(19) United States
(12) Patent Application Publication
(10) Pub. No.: US 2009/0199339 A1
(43) Pub. Date: Aug. 13, 2009

(54) MEDICAL EXAMINATION TABLE AND SYSTEM FOR MOUNTING ACCESSORIES TO THE TABLE

(75) Inventor: Rodney Barr, Cary, NC (US)

Correspondence Address: COATS & BENNETT, PLLC, 1400 Crescent Green, Suite 300, Cary, NC, 27518, US

(73) Assignee: MARTIN MANUFACTURING COMPANY, LLC, Rocky Mount, NC (US)

(21) Appl. No.: 12/369,117

(22) Filed: Feb. 11, 2009

Related U.S. Application Data
(60) Provisional application No. 61/027,624, filed on Feb. 11, 2008.

(51) Int. Cl. A47B 13/00; A61G 7/00; A47B 13/16; A61G 7/05; A47C 21/08

(52) U.S. Cl. 5/602; 5/600; 5/649; 5/658; 5/428; 5/613

(57) ABSTRACT

A medical examination table system includes a medical examination table having one or more moveable sections for supporting a patient. One or more supports are secured to the medical examination table and there is provided at least one coupling that is slidably mounted on one of the supports and movable back and forth thereon. The slidably mounted coupling includes a receptor that receives and holds an accessory such that the accessory and the coupling are movable back and forth on the support with respect to the examination table.

### CROSS REFERENCE TO PROVISIONAL APPLICATION

This application claims priority under 35 U.S.C. §119(e) from the following U.S. provisional application: Application Ser. No. 61/027,624 filed on Feb. 11, 2008. That application is incorporated in its entirety by reference herein.

### FIELD OF THE INVENTION

The present invention relates to medical examination tables and accessories used with such examination tables.

### SUMMARY OF THE INVENTION

In one embodiment, there is provided a medial examination table. Secured to the medical examination table is one or more supports. A coupling is slidably mounted on at least one of the supports and is movable back and forth thereon. The coupling includes a receptor for receiving and holding an accessory such that when the accessory is connected to the coupling, both the accessory and the coupling may move back and forth on the support.

In addition, disclosed herein is a method for configuring a medical examination table to receive and support one or more accessories. The method includes attaching a support to the medical examination table and slidably mounting a coupling to the support such that the coupling can move back and forth on the support. One or more clinical accessories is connected to the coupling such that the coupling and the clinical accessory can move back and forth on the support with respect to the examination table.

Other objects and advantages of the present invention will become apparent and obvious from a study of the following description and the accompanying drawings which are merely illustrative of such invention

### BRIEF DESCRIPTION OF DRAWINGS

FIG. 1 is a perspective view of a portion of a medical examination table having an accessory support structure.

FIG. 2 is another perspective view of a portion of a medical examination table having a number of accessories secured thereto and disposed in the patient reclining or prone orientation.

FIG. 3 is another perspective view of a portion of a medical examination table wherein an accessory is mounted to the footrest of the examination table.

FIG. 4A is a perspective view of a portion of the medical examination table showing the table in a gynecological examination configuration and with an accessory attached to the footrest.

FIG. 4B is a fragmentary perspective view of a portion of the examination table shown in FIG. 4A.

FIG. 5A is a perspective view of a support adapted to connect to the medical examination table for supporting accessories.

FIG. 5B is an exploded fragmentary perspective view of the examination table showing the support that is adapted to connect to the examination table.

FIG. 6 is a perspective view of a coupling adapted to be secured to the support.

FIG. 7 is a fragmentary perspective view showing the footrest of an examination table and an accessory supported indirectly by the footrest.

FIG. 8A is an exploded perspective view of an accessory frame and a medical pan clinical accessory.

FIG. 8B is a perspective view of a clinical accessory comprising a medical pan held in the accessory frame.

FIG. 9A is a fragmentary perspective view of the medical examination system as illustrated in FIG. 4A with the interior the footrest section revealed.

FIG. 9B is a schematic diagram showing a safety interlock.

FIG. 10A is a perspective view of an accessory storage device.

FIG. 10B is a fragmentary perspective view of an extruded aluminum rail employed in the accessory storage device.

FIG. 11 is a perspective view of the medical examination table having a plurality of table width extensions connected thereto.

FIG. 12 is a view similar to FIG. 11 illustrating how one table width extension can be detachably mounted to the examination table.

### DESCRIPTION OF THE INVENTION

With particular reference to the drawings, the present invention relates to a system including a medical examination table, indicated generally by the numeral 100. The medical examination table may be configured for supporting a patient in various orientations during a medical examination or other medical procedure. For a more general description of a medical examination table, reference is made to U.S. patent application Ser. No. 11/453,665 entitled “Examination Table”, the disclosure of which is hereby incorporated in its entirety.

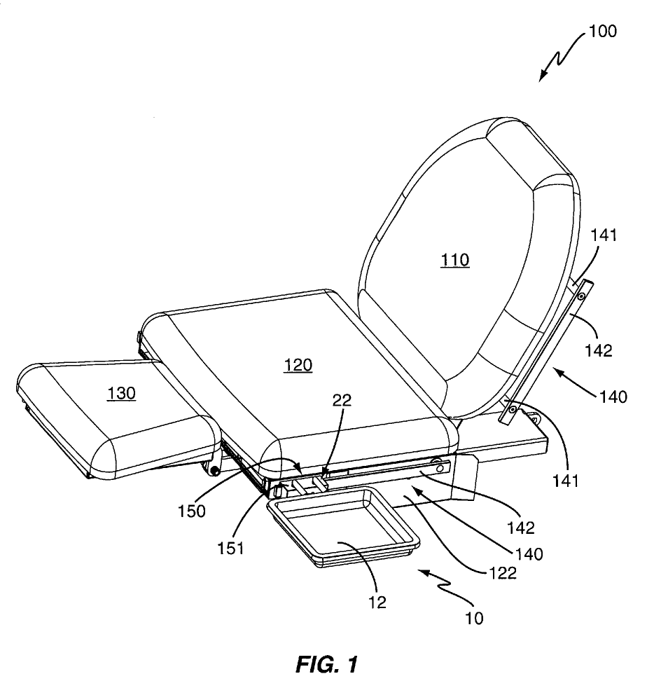

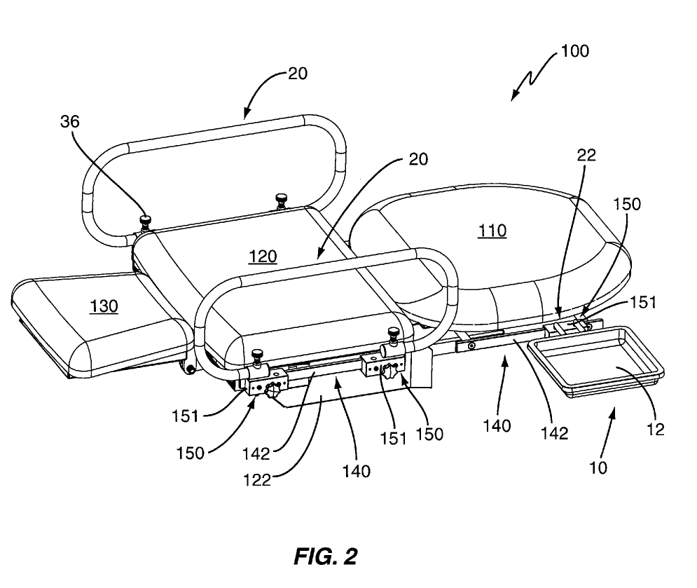

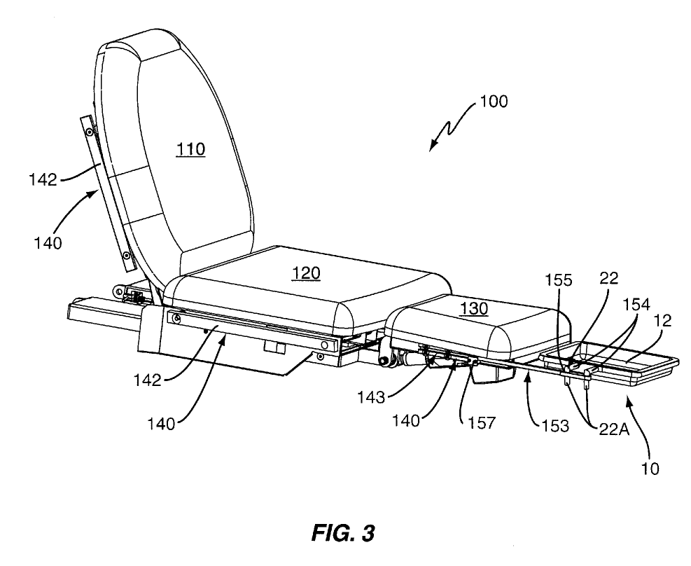

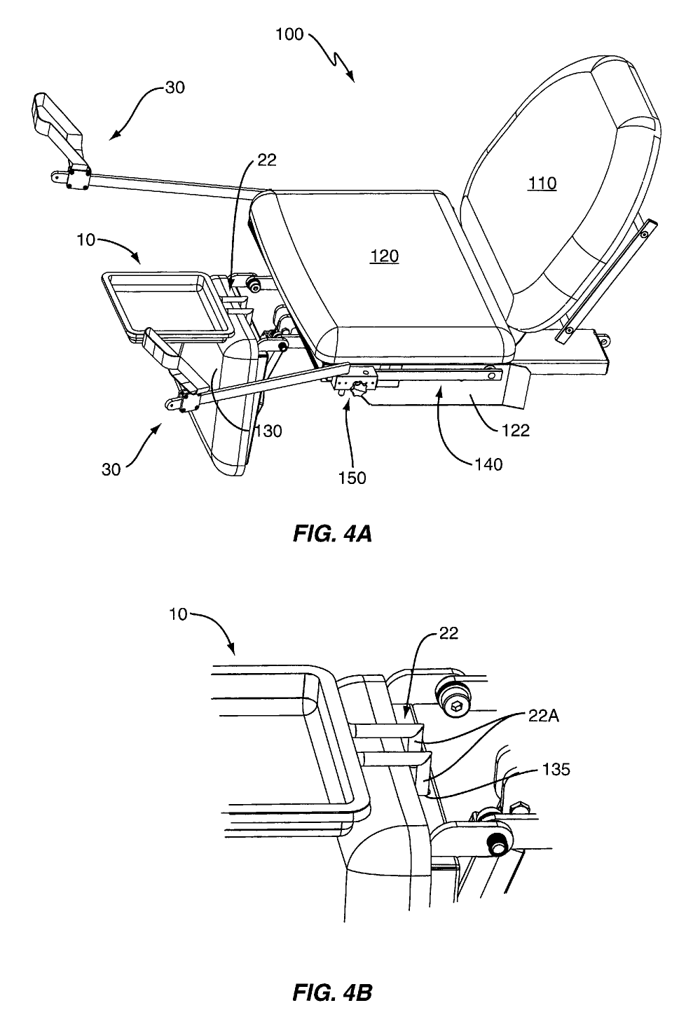

In one embodiment, medical examination table 100 includes several sections for supporting various portions of the patient. Medical examination table 100 includes an upper body section 110, a lower body section 120, and a footrest section 130. Each of these sections include a base frame, such as a metal frame, and an upholstered surface. Sections 110, 120, 130 are movable relative to one another such that medical examination table 100 supports the patient in various positions. For example, as shown in FIG. 1, medical examination table 100 may support the patient in an upper body raised or sitting position. FIG. 2 shows examination table 100 with the sections moved relative to one another to form a generally horizontal support for a recumbent or prone patient position. FIG. 3 shows medical examination table 100 configured for performing an examination or procedure on the lower extremities or feet. FIG. 4A shows medical examination table 100 with the sections positioned for performing a gynecological examination. It is appreciated the medical examination table 100 may include additional sections, and that various other relative orientations of the several sections may be accomplished by the table.

Included in the system and associated with medical examination table 100 are one or more accessories, such as a medical pan 10, that may be secured to and stationed alongside the table as illustrated in FIGS. 1, 2, and 3. The present invention entails a plurality of other accessories including side rails 20 (FIG. 2), stirrups 30 (FIG. 4A) and other clinical accessories including but not limited to intravenous infusion support poles, monitoring and drug delivery instrument supports, and patient restraints.

These accessories are supported on medical examination table 100. In one embodiment, shown in FIGS. 1 and 2, medical pan 10 is connected to a support 140 by a slidable coupling 150. Coupling 150, to be described in more detail hereinafter, is connected to support 140 and capable of sliding back and forth along the support while supporting medical pan 10, for example. Also, with one or more of the same or similar couplings 150, an accessory may be stationed and locked at a particular position adjacent medical examination table 100 and may be unlocked and re-stationed. For example, side rail 20 may be connected to a pair of couplings 150 and locked in position alongside the seat section 120 of the table as illustrated in FIG. 2. As another example, a stirrup 30 may be connected to coupling 150 and locked into position as shown in FIG. 4A.

Accessories may also be generally fixedly, rather than slidably, connected to medical examination table 100 for particular applications. For example, medical pan 10 may be connected to openings or receivers formed in the footrest 130 of medical examination table 100 as illustrated in FIGS. 4A and 4B. Prongs 22 extend from medical pan 10 and are inserted into receivers or openings 135 such that the pan is supported by footrest section 130. In this example, medical examination table 100 is configured for a gynecological examination wherein footrest section 130 is moved to a generally vertical orientation and stirrups 30 provide foot support.

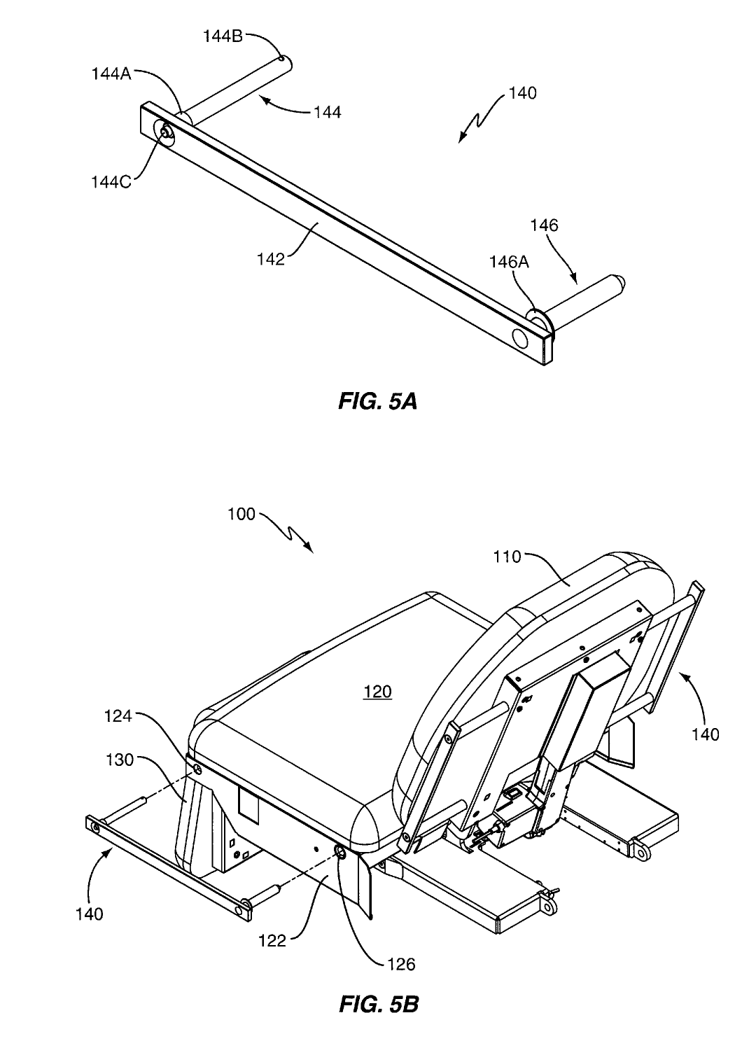

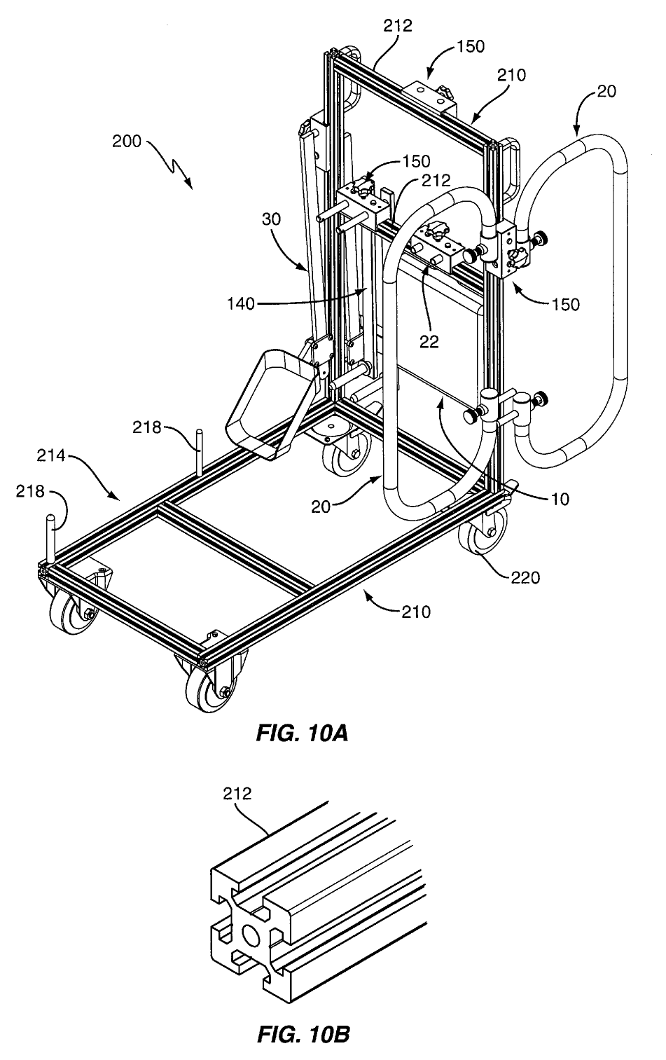

The present invention also provides a storage device 200 for use with medical examination table 100 to store accessories and other components while not in use. As seen in FIG. 10A, storage device 200 comprises a cart frame 210 supported on wheels or casters 220. Cart frame 210 includes one or more storage rails 212 to which couplings 150 are connected. In one embodiment, rails 212 are formed from extruded aluminum as illustrated in FIG. 10B. Accessories such as medical pans 10, side rails 20 and stirrups 30 as well as supports 140 may be connected to couplings 150 and stored on device 200. Storage device 200 also includes a platform portion 214 for storage of larger components such as removable sections of medical examination table 100 and removable side panels of wheel chairs. In one embodiment, seat section 120 is removable from the examination table. It may be desirable to store section 120 on platform 214 of the cart 200. As seen in FIG. 5B, section 120 includes a pair of spaced apart openings 124 and 126. Pins 218 project from the platform and are spaced so as to be insertable within openings 124 and 126 of seat section 120. Utilizing storage device 200, accessories may be compactly stored when not in use and conveniently positioned near medical examination table 100.

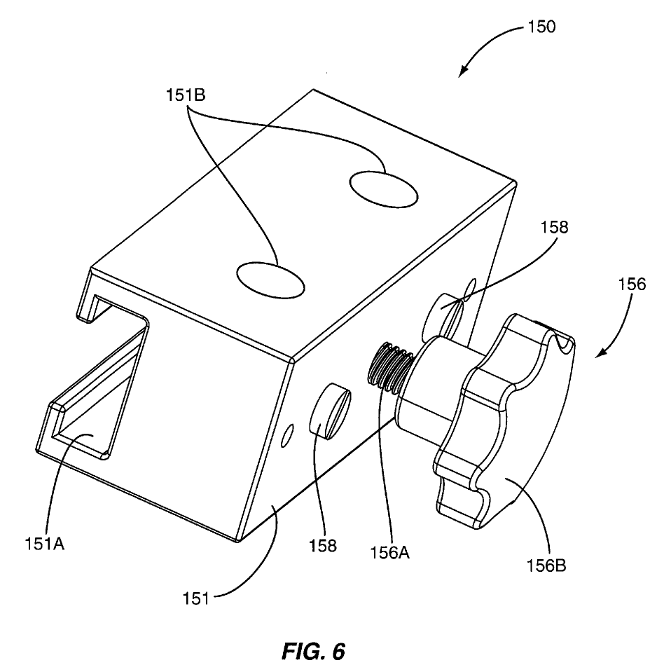

Turning now to a more detailed discussion of the exemplary structure for connecting accessories to medical examination table 100, each support 140 is secured adjacent one section of the table and coupling 150 is slidably mounted on the support as discussed above. In one embodiment, each support 140 includes bar 142 secured adjacent one section of table 100 as illustrated in the drawings. In this embodiment, coupling 150 comprises a block 151 having a C-shaped recess or channel 151A as shown in FIG. 6. Channel 151A is sized to receive bar 142 such that block 151 is slidable along the bar. Block 151 also includes spaced apart openings or receptors 151B for receiving accessories as will be discussed hereinafter. Coupling 150 may, in one embodiment, also include a locking device 156. In one embodiment, locking device 156 includes a screw 156A and a knob 156B. Screw 156A extends within a threaded opening and partially into channel 151A to contact bar 142 for stationing coupling 150 at a particular position along the bar. Coupling 150 may also include set screws 158 extending at least partially within receptors or openings 151B for securing accessory prongs that are inserted therein.

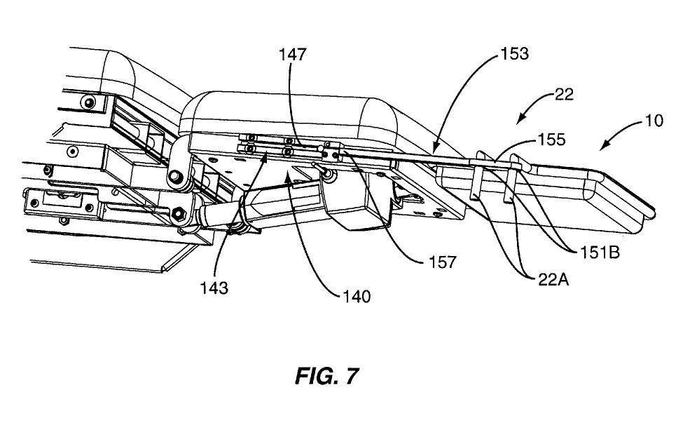

In one embodiment, support 140 includes a slide 143 secured to table 100 as shown in FIGS. 3 and 7. In this embodiment, coupling 150 comprises an arm 153 with spaced apart openings or receptors 154 disposed in one end portion 155 to receive portions of one ore more prongs 22 and hold one or more accessories, such as medical pan 10 for example. An opposite end portion 157 is sized to insert within a channel 147 formed in slide 143. End portion 157 is sized to accomplish a slidable friction fit within channel 147 such that arm 153 may be stationed at any of various positions along slide 143 to position pan 10, for example, at various locations relative to footrest 130. Alternatively, or in addition, a locking device or lock screw may incorporated into slide 143 or arm 153 to station the arm in a given position.

In one embodiment support 140 is removably connected to medical examination table 100 such that bar 142 is disposed outwardly of the table adjacent section 120, for example, as shown in FIGS. 1, 2, and 3. In this embodiment, support 140 is easily mountable and detachable. Spaced apart mounting pins 144 and 146 extend generally perpendicularly from bar 142 as illustrated in FIGS. 5A and 5B. Support 140, as illustrated in FIG. 5B, is removably secured to medical examination table 100 by inserting pins 144, 146 into openings 124, 126 in section 120 of the table. A shoulder 144A nests into a counter bore in opening 124, and a flange 146A rests against side member 122 of section 120. In one embodiment, pin 144 includes a locking device such as ball detent 144B to engage a seat disposed interiorly of opening 124 such that when pin 144 is inserted into the opening, the pin is locked within the opening. A detent release button 144C is provided for releasing the ball detent when removing support 140 as will be discussed further hereinafter. In one embodiment, pin 144 is somewhat longer than pin 146, the difference in the lengths to facilitate ease of mounting support 140 to the table as will also be discussed in more detail hereinafter. It is appreciated that a ball detent 144B and associated release button 144C may be disposed on either or both of pins 144, 146. Further, either pin 144 may be longer than pin 146 or pin 146 may be longer than pin 144.

In some embodiments, support 140 may be secured in a generally non-removable manner to medical examination table 100. That is, in these embodiments, support 140 is not configured to be easily removable in the course of normal use of medical examination table 100. In one such embodiment, support 140 includes a bar 142 secured adjacent backrest section 110 as seen in FIGS. 1, 2, and 3. Bar 142 may be secured to table 100 using sleeved bolts or screws 141 such that the bar is offset outwardly from backrest section 110.

In one embodiment, receivers 135 may be formed in a portion of medical examination table 100 in order to connect accessories without the use of support 140 or coupling 150. For example, as illustrated in FIGS. 4A and 4B, medical pan 10 may be connected to vertically oriented footrest 130 by means of prongs 22 inserted into openings or receivers 135 in the footrest. Such a configuration may be typical when using the medical examination table 100 for performing gynecological examinations and procedures.

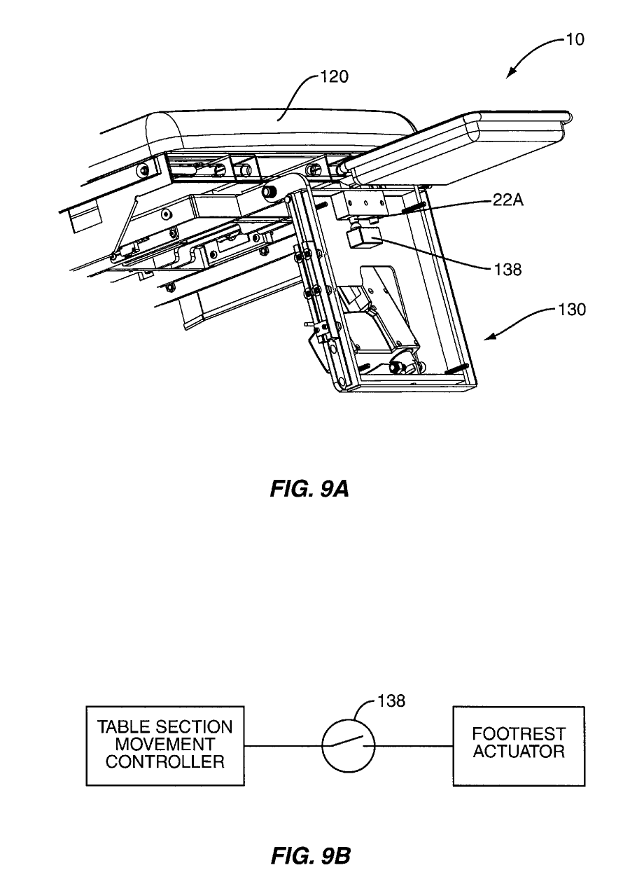

A safety interlock 138 is disposed on footrest 130 to prevent inadvertent movement of the footrest while the accessory is mounted to the footrest. In one embodiment, safety interlock 138 is a normally-closed switch mounted such that when an accessory is connected to footrest 130, a prong 22 of the accessory engages and opens the switch. As shown in FIG. 9B, safety interlock or switch 138 is connected in series in the circuit from the table section movement controller to the footrest actuator. When switch 138 is engaged by prong 22, the circuit opens, preventing energization of the footrest actuator and thereby preventing motion of footrest section 130 while the accessory is connected thereto.

Turning now to the accessories included in medical examination table 100, as noted above the accessories may include various clinical accessories that may be of utility in conducting medical examinations and procedures. Included among the accessories is a medical pan 10 as illustrated in various drawings including FIGS. 1, 2, and 3. Medical pan 10 includes a pan portion 12 for holding various medical instruments and materials. Extending from pan portion 12, in one embodiment, are a pair of projections or prongs 22 having bent portions 22A that are inserted into receptors 151B in coupling 150 or arm 143 such that pan 10 is connected to the coupling or arm and supported adjacent medical examination table 100.

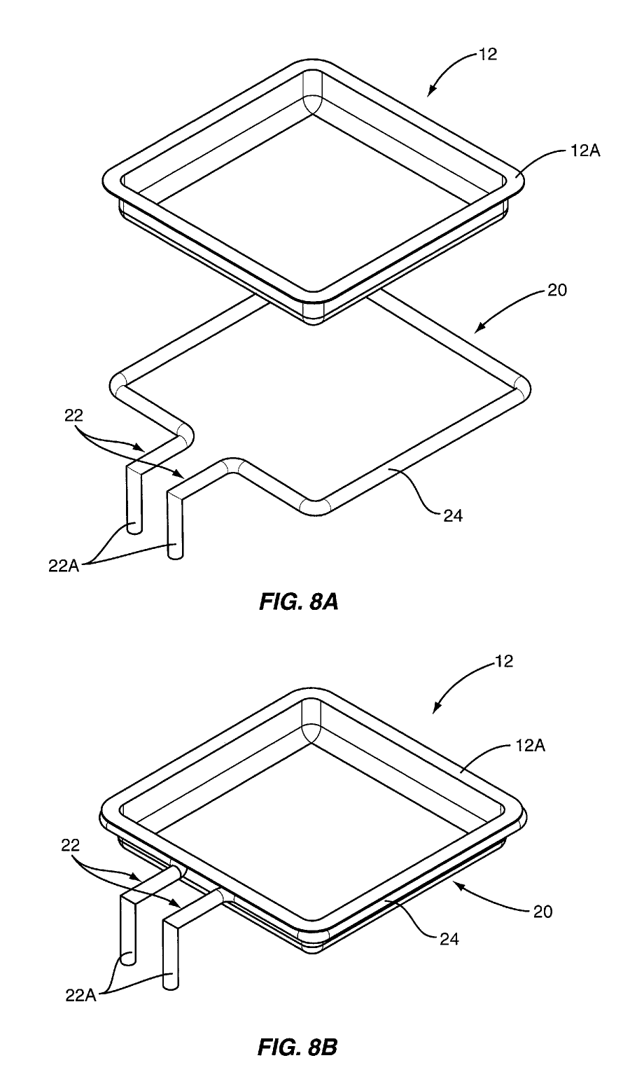

In one embodiment, medical pan 10 comprises a pan portion 12 and an accessory holder such as pan holder 20 as illustrated in FIGS. 8A and 8B. In this embodiment, pan portion 12 is separable from pan holder 20. Pan holder 20 includes a rod bent into a loop and forming a rim 24 for supporting lip 12A of pan portion 12. Extending from the loop are projections or prongs 22 with bent portions 22A. Bent portions 22A are inserted into receptors 151B to attach pan holder 20 to coupling 150, for example. Pan portion 12 may be inserted into the loop with lip 12A supported on rim 24 to connect the pan portion to medical examination table 100.

Other accessories include, but are not limited to, side rails 30, stirrups 40 and various instrument or IV stands. Each such accessory or associated accessory holder includes one or more prongs 22, a portion of which may be inserted into receptors 151B in block 151 or arm 143.

If one or more of the accessories are to be positioned adjacent one of the sections 110, 120, and 130, a sufficient number of blocks 151 are selected and mounted onto bars 142. Blocks 151 may be stationed and secured at certain positions using locking device 156 or may be left free to slide back and forth as needed during the medical examination or procedure. It is appreciated that bars 142 may have one block 151 generally continuously mounted thereto, and that additional blocks may be added as required for a particular examination or procedure. Various of the accessories may then be connected to blocks 151. For example, if medical pan 10 is to be mounted adjacent backrest 110, prongs 22 are inserted into receptors 151B of block 151 mounted onto bar 142 adjacent the backrest. In a further example, bedrails 20 may be connected to each side of section 120 by adequately spacing a pair of blocks 151 apart along bar 142 and inserting a bedrail prong (not shown) into one of the openings 151B of each block. Each block 151 may be stationed and locked in place by tightening locking device 156. Bedrail 20 may be positioned and held in an upright orientation as illustrated in FIG. 2 by tightening screws 36, or the bedrail may be positioned out of the way by loosening screws 36 and rotating the bedrail downwards.

In the case of preparation for a gynecological examination or procedure, footrest 130 is positioned in a vertical orientation as shown in FIG. 4A. Medical pan 10 is connected to receivers 135 mounted or formed in the frame of footrest section 130 such that at least one prong 22 engages locking device 138. As described above, locking device 138 prevents footrest section 130 from being inadvertently moved while an accessory is connected to the footrest section. As may be further required or desired, stirrups 30 may be connected to the examination table 100. In one embodiment, stirrups 30 include a prong (not shown) for insertion into receptor 151B of a block 151. Locking screws 158 in block 151 may be tightened to secure stirrups 30 at a desired position on table 100.

Accessories and supports 140 may be removed from medical examination table 100 generally by reversing the processes described above. Removed accessories and supports may be connected to and supported by couplings 150 that are mounted onto rails 212 of storage device 200. Storage device 200 may be placed in a desirable storage location until the accessories and other components are required for use with medical examination table 100.

Another accessory for the examination table 100 is a series of attachable sections used to increase the width of the examination table. In one embodiment these attachable sections are detachably mounted to each of the sections 110, 120 and 130 of the table. For example, in one embodiment there is an attachable section that is attached to the footrest section 130 and extends at least along opposite sides of the footrest to effectively widen the footrest. In addition, attachable sections are adapted to detachably connect to both of the other table sections, sections 110 and 120, so as to effectively widen each of these sections. The shape, size, and general construction of the attachable sections can vary. In one embodiment, each of the attachable sections would include an upholstered portion. Various mechanisms can be utilized to connect the attachable sections to the examination table. For example, a pin and opening arrangement like that shown in FIGS. 5A and 5B can be utilized to connect each attachable section to one of the sections 110, 120 and 130 of the examination table. That is, each of the attachable sections would include one or more pins that project outwardly therefrom and which are configured to detachably connect into one or more openings formed in the examination table.

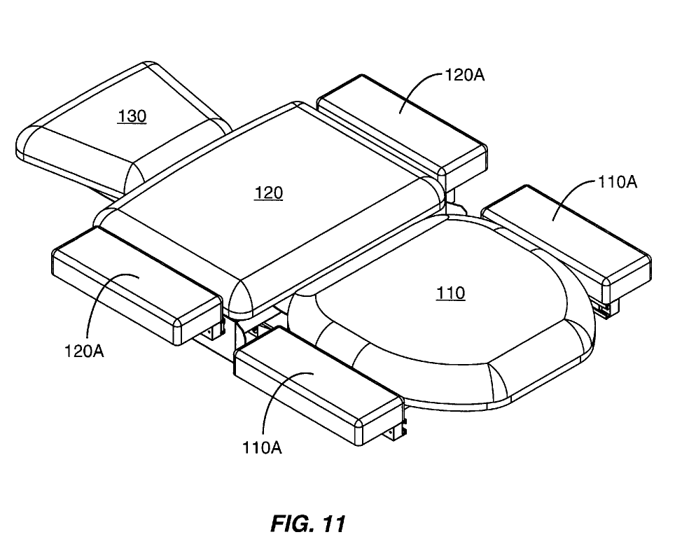

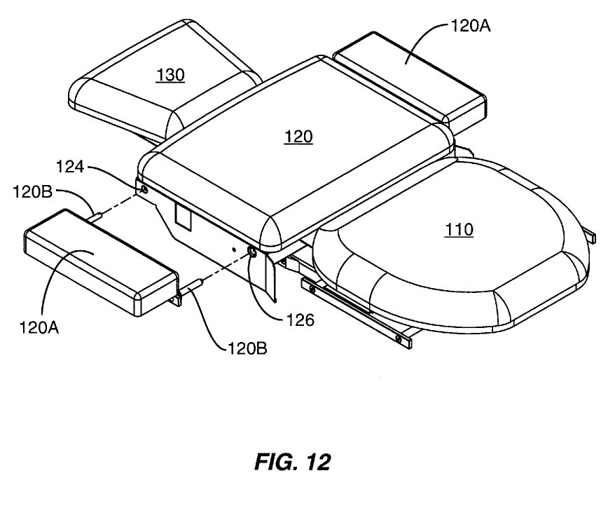

With reference to FIGS. 11 and 12, there is shown therein the examination table with a plurality of table width extensions detachably secured thereto. In FIG. 11, there are two table width extensions 120A secured to opposite sides of the seat section 120. Likewise, connected to opposite sides of the back rest 110 are two table width extensions 110A. Although there are no table width extensions secured to the footrest 130, it will be appreciated by those skilled in the art that table width extensions can be provided for attaching to the footrest 130.

In the embodiment illustrated herein, the table width extensions are detachably secured to the respective sections of the examination table. Various means and approaches can be utilized for detachably coupling respective table width extensions to the examination table. FIG. 12 illustrates one approach. Here, table width extension 120A is provided with a pair of pins 120B. These pins are insertable into openings 124 and 126 formed in the frame of the seat portion 120. As with the support structure shown in FIGS. 5A and 5B, at least one of the pins 120B shown in FIG. 12 is provided with a locking device for locking the table width extension 120A into a locked position adjacent one side of the seat portion 120. In some cases, it may be desirable to provide the table width extensions with slides. The slides would include built-in accessory clamps that fit onto the side rails of the examination table. For example, note in FIG. 1 where the back rest 110 includes side rail or support 142. The table width extensions 110A could be designed to clamp onto the side rails 142 that extend along one side of the back rest 110.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. A medical examination table system comprising:
a. a medical examination table including one or more sections for at least partially supporting a patient;
b. one or more supports secured to the medical examination table;
c. at least one coupling that is slidably mounted on one of the supports and movable on the support; and
d. the slidably-mounted coupling including a receptor for receiving and holding an accessory such that the accessory and the coupling holding the accessory are movable with respect to the medical examination table.

2. The medical examination table of claim 1, wherein the support includes an elongated bar detachably mounted to one section; the bar including two spaced apart pins projecting therefrom, the pins insertable into first and second openings in at least one section; and wherein at least one of the pins includes a locking device which secures the pins within one of the openings in the section.

3. The medical examination table of claim 2, wherein the coupling includes a block having a C-shaped channel extending through the block and wherein the bar projects through the channel and supports the block for sliding movement on the bar; wherein the block includes two spaced apart openings formed in a side thereof for receiving accessory projections; and wherein the block is mounted on the bar such that the side having the openings formed therein forms the top of the block when the block is mounted on the bar.

4. The medical examination table of claim 3, wherein the block includes one or more screws for engaging one or more accessory projections received by the block and locking the accessory projections in the block.

5. The medical examination table system of claim 2 wherein one of the first and second pins is longer than the other.

6. The medical examination table of claim 2, further comprising an accessory support including one or more projections configured to be inserted into one or more openings in the coupling such that the accessory support is supported by the coupling and extends therefrom.

7. The medical examination table of claim 1, wherein the coupling includes a block having a C-shaped channel extending through the block and wherein the support includes a bar projecting through the channel and supporting the block for sliding movement on the bar; and wherein the block includes two spaced apart openings formed in a side thereof for receiving accessory projections; and wherein the block is mounted on the bar such that the side having the openings formed therein forms the top of the block.

8. The medical examination table of claim 1 further comprising a plurality of table width extensions, each table width extension being mounted to the examination table for extending the width of the examination table.

9. The medical examination table system of claim 2 further including one or more clinical accessories mounted on one or more of the couplings.

10. The medical examination table system of claim 2 including an accessory frame for mounting to the coupling and holding a clinical accessory, and wherein the accessory frame and the clinical accessory are two separate and independent structures.

11. The medical examination table system of claim 10 wherein the accessory frame comprises a rim for engaging and supporting a pan for holding instruments or supplies, and wherein at least one projection extends from the rim for connecting to the receptor of one coupling.

12. The medical examination table system of claim 10 wherein the accessory frame comprises a rod that is bent to form at least a portion of a loop and at least one projection, the loop adapted to receive and hold a pan and the projection adapted to engage the receptor of the coupling such that the accessory frame and the pan are attached to the coupling and supported by the support.

13. The medical examination table system of claim 10 including one or more clinical accessories selected from the group including a pan for holding instruments or supplies, a stirrup for use in gynecological examinations, a pole for supporting intravenous fluids or instruments, a medical instrument, and a side rail for preventing a patient from falling from the table.

14. The medical examination table system of claim 1 wherein the sections include a footrest and the support is secured to the footrest, and wherein the coupling is slidable back and forth relative to the support and the footrest.

15. The medical examination table system of claim 1 including an accessory storage device for receiving and storing one or more accessories or other structures, the accessory storage device includes one or more bars configured such that one or more of the couplings may be slidably mounted thereto to receive and hold one or more accessories, whereby the couplings can be used on both the examination table and the storage device to support accessories.

16. The medical examination table of claim 1, wherein the accessory comprises a side rail configured to be attached to two spaced apart couplings mounted on the support, and wherein the side rail is rotatable from an upright retaining position to a lower position where the side rail extends below the couplings.

17. A medical examination table system adapted to be configured for a gynecological examination comprising: a medical examination table for at least partially supporting a patient and including first and second sections with one section being moveable relative to the other; the first and second sections including a footrest having a frame and an upholstered surface; the footrest being moveable between a generally vertical position and a generally horizontal position; a receptor secured to the frame of the footrest and having one or more openings formed therein; an accessory secured to the receptor attached to the frame of the footrest; and wherein when the medical examination table assumes a gynecological examination configuration, the accessory projects outwardly past the footrest which is disposed in the generally vertical position.

18. The medical examination table system of claim 17 including one or more accessory supports secured to the medical examination table; at least one coupling slidably mounted on one support and movable back and forth thereon; the coupling including a receptor for permitting the coupling to be connected to an accessory; and a stirrup having at least one projection for connecting to the receptor of the coupling such that the stirrup is supported by the coupling and slidably mounted to the medical examination table.

19. The medical examination table system of claim 18 including a safety interlock that senses whether the accessory is secured to the receptor, and prevents movement of the footrest section of the medical examination table when the accessory is secured to the receptor table.

20. A method of configuring a medical examination table to receive one or more accessories wherein the examination table includes one or more patient support sections that engage and support a patient, the method comprising:
a. detachably connecting an accessory bar to a frame of one of the sections of the examination table;
b. detachably connecting the accessing bar includes inserting one or more pins projecting from the accessory bar into one or more openings in the frame of the section of the examination table;
c. locking the pin in the opening of the section so as to lock the accessory bar adjacent the section;
d. slidably mounting a coupling on the accessory bar where the coupling is adapted to receive and support a clinical accessory; and
e. selecting one or more clinical accessories and connecting one of the accessories to the coupling such that the coupling and the one or more attached clinical accessories can slide back and forth on the accessory bar.

21. The method of claim 20, wherein the coupling includes a block having a channel and the method includes extending the channel around the accessory bar such that the accessory bar extends through the channel; and providing one or more openings on an upper surface of the block and inserting one or more projections extending from the accessory into the one or more openings formed in the block.

22. The method of claim 20, wherein the accessory bar includes two pins projecting therefrom, one pin being longer than the other; and the method includes inserting the two pins into openings formed in the frame of one of the sections of the examination table.

23. An accessory for attaching to a medical examination table, comprising: an open frame configured and shaped to form a pan or tray receiving portion, the open frame including an attaching portion configured to connect to a support on the examination table; and a pan or tray configured to be supported on the frame and wherein the pan or tray is shaped and sized to seat in the pan or tray receiving portion of the frame.

24. The accessory of claim 23, wherein the pan or tray includes a disposable pan or tray and further including a disposable kit associated with the pan or tray.

25. The accessory of claim 24, wherein the disposable kit is a medical disposable kit including instruments or supplies used in a medical procedure.

26. The accessory of claim 23, wherein the pan or tray receiving portion comprises a generally square or rectangular shaped frame and wherein the attaching portion includes one or more projections projecting therefrom and configured to be inserted within openings associated with the medical examination table.

27. A medical examination table, comprising:
a. a plurality of table sections with the individual table sections being movable with respect to each other;
b. the table sections including a seat portion and a back rest;
c. a plurality of table width extensions; and
d. at least one of the table width extensions being detachably mounted to one side of the seat portion or back rest.

28. The medical examination table of claim 27, wherein at least one table width extension includes a pair of spaced apart pins; and wherein at least one of the table sections include a pair of spaced apart openings formed therein for receiving the pins and permitting the table width extension having the pins to be detachably secured to the table section.
